(19) United States
(12) Patent Application Publication
(10) Pub. No.: US 2019/0307650 A1
(43) Pub. Date: Oct. 10, 2019

(54) MULTI-PURPOSE TEETHING DEVICE

(71) Applicant: Chill Chomps LLC, Seattle, WA (US)

(72) Inventor: Holly Dentz, Seattle, WA (US)

(21) Appl. No.: 16/371,746

(22) Filed: Apr. 1, 2019

Related U.S. Application Data
(60) Provisional application No. 62/654,709, filed on Apr. 9, 2018.

(51) Int. Cl. A61J 17/02

(52) U.S. Cl. CPC A61J 17/02

(57) ABSTRACT

The present disclosure provides for a multi-purpose teething device safe for use by both caregivers and teething children. The multi-purpose teething device includes a body and an extension. A teething child can hold the body while chewing or biting on any part of the device. A caregiver can insert their finger into the extension and massage or rub the teething child's gums to relieve a child's teething associated pain inflammation. In this way, the teething device is a multi-purpose device.

### CROSS-REFERENCES TO RELATED APPLICATIONS

This application claims priority under 35 U.S.C. § 119(e) to U.S. Provisional Application No. 62/654,709 filed on Apr. 9, 2018, the entire contents of which are herein incorporated by reference for all purposes.

### TECHNICAL FIELD

The invention detailed herein generally relates to infant and children care devices, and more specifically relates to infant and children teething devices.

### BACKGROUND OF THE INVENTION

Teething is a process by which baby teeth break through an infant's gums. This process is often painful for the child and can lead to swelling and inflammation of the teething child's gums. Current teething recommendations indicate that two of the most effective ways to sooth a teething child's gums are to rub or massage the gums with a finger and apply cold. Currently, to mitigate the pain and inflammation, teething children will bite on their fingers and other toys to help relieve the teething associated pain and pressure. Teething children will also bite their caregiver's fingers, thereby relieving some of the pain associated with teething. Finally, caregivers also massage a teething child's gums with their own fingers. Each of these techniques has its shortcomings, which are addressed by the multi-purpose teething device of the present disclosure.

Current teething devices focus on providing devices for teething infants to bite or chew on. For example, U.S. Pat. No. 9,480,626 describes a substantially arc-shaped and elastically deformable teething element for infant use. U.S. patent application publication 2009/005810 describes a teething device designed with a handle for infants and toddlers. Other well-known devices in the art are similar, providing some sort of object for the teething child to use on their own.

A teething tip for an adult's finger has been described in U.S. patent application publication 2013/0245687. However, the tip, a flexible cover for an adult's finger, presents a choking hazard to the infant and is unsafe for use by a child alone. The tip also does not provide any cooling mechanism.

### BRIEF SUMMARY OF THE INVENTION

A multi-purpose teething device usable by caregivers and infant children to provide relief from teething associated pain and inflammation. The multi-purpose teething device has a body that includes one or more chewable protrusions made of an elastomeric material. At least a portion of the one or more chewable protrusions has a textured surface. Further, a hygienic chewable extension made of an elastomeric material extends outward from the body. The hygienic chewable extension has an outer surface, an inner surface, and an opening. The inner surface defines a cavity, and the cavity is adapted to receive at least a portion of a human finger through the opening.

### BRIEF DESCRIPTION OF THE DRAWINGS

FIG. 1 illustrates one embodiment of the multi-purpose teething device.

FIG. 2 illustrates a caregiver using one embodiment of the multi-purpose teething device.

FIG. 3 illustrates another embodiment of the multi-purpose teething device.

### DETAILED DESCRIPTION OF THE INVENTION

Existing teething devices do not provide an effective way for a caregiver to massage a teething child's gums. Moreover, existing teething devices do not provide a safe and effective teething device usable by both caregivers and teething children to provide relief from teething associated pain and inflammation. Certain embodiments of the present disclosure provide caregivers and teething children a device to relieve teething associated pain and inflammation. The multi-purpose teething device can be used safely by either a caregiver or a child. A caregiver can insert their finger into a hygienic chewable extension on the device, providing a means for the caregiver to massage the teething child's gums. Providing a hygienic chewable extension is beneficial over chewing on a bare finger for several reasons. First, the hygienic chewable extension prevents germs from being transferred between the caregiver's finger and the teething child's mouth, thereby reducing the likelihood of teething associated sickness or infection. Second, the hygienic chewable extension may include a variety of patterns and textures suitable to providing maximum relief to the teething child. Third, the tip is of a sufficient thickness to protect the caregiver's finger from being directly bitten by the teething child, and to prevent the child's teeth from perforating the outer surface of the hygienic chewable extension.

Moreover, the multi-purpose device is safe for unassisted use by the teething child. Because the hygienic chewable extension extends outward from a body of the device, the hygienic chewable extension does not present a choking hazard for the teething child. Unlike teething tips described in the art, the shape of the body prevents the device from being inserted far enough into a teething child's mouth to cause the teething child to choke. It is possible to imagine a multitude of different body shapes that are capable of achieving this function. Accordingly, the body can take any size or shape configured to prevent the teething child from choking on any portion of the device.

Furthermore, the body of the multi-purpose teething device comprises one or more protrusions that provide a means for holding the device should a teething child wish to use the device without the assistance of a caregiver. Accordingly, an unassisted teething child is capable of biting or chewing on any part of the multi-purpose teething device, such as the hygienic chewable extension or the body, without the threat of choking on the device and without the need of caregiver assistance.

The multi-purpose device can also have a means for providing a cooling sensation to the teething child. This is often through the use of a second and third cavity located on the hygienic chewable extension and the body of the device, respectively. The second and third cavity can be filled with a liquid or gel that can retain cooling properties after the device is removed from a refrigerator or freezer.

The multi-purpose teething device may also have one or more handles providing another place for a teething child to grip the device. In some embodiments, the multi-purpose teething device also provides an interface for attachments. The interface may be the one or more handles, or may be any other interface sufficient to secure an attachment. Such attachments may include, for example, a clip connected to a pacifier or any other child-care related device.

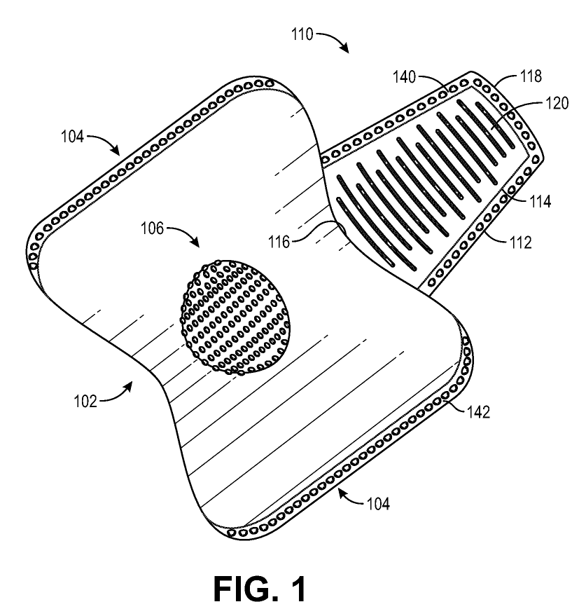

FIG. 1 illustrates one possible embodiment of the multi-purpose teething device. As shown in FIG. 1, a hygienic chewable extension 110 extends outward from a body 102. The body 102 further comprises one or more chewable protrusions 104.

In some embodiments, the body 102 and the hygienic chewable extension 110 can be made from the same manufacturing mold. In other embodiments, the body 102 and the hygienic chewable extension 110 can be made from two separate manufacturing molds and attached together via a suitable bonding material known in the art. For example, a suitable bonding material could be FDA approved silicone. Moreover, in some embodiments, the body 102 and the hygienic chewable extension 110 can be made of the same material. In other embodiments, the body 102 and the hygienic chewable extension 110 can be made of different material.

The chewable protrusion 104 provides a teething infant or child a place to hold the device and/or a place to bite or chew. The chewable protrusions can be in any shape or size that provides an adequate surface for the teething child to bite or chew and/or for the teething child to hold.

In some embodiments, the body 104 may also provide a textured surface 106, covering all or a portion of the body and/or the chewable protrusion 104. When a teething child bites or chews on the textured surface 106, they feel a different sensation than when they chew on a non-textured surface of the body 102 or the chewable protrusion 104. In some embodiments, the body may also include a third cavity 142 capable of containing a cooling gel or liquid.

As shown in FIG. 1, the hygienic chewable extension 110 extends outward from the body 102, and further comprises an end 116 proximal to the body 102 and an end 118 distal to the body 102. The hygienic chewable extension further comprises an outer surface 112 and an inner surface 114. The inner surface 114 defines a cavity 120 within the hygienic chewable extension 110. The cavity 120 is configured to receive a human finger. In some embodiments, the human finger is a caregivers' finger, and the caregiver can direct the hygienic chewable extension 110 into the teething child's mouth to massage the teething child's gums and otherwise provide pressure.

In some embodiments, the body 102 and the hygienic chewable extension 110 are made of an elastomeric material. The elastomeric material may be any natural or synthetic nontoxic material. For example, the elastomeric material may be a rubber material. The rubber material could be any FDA approved rubber material intended for repeated use, as designated in 21 C.F.R. § 177.2600(c)(4), which is incorporated by reference. In some embodiments, the rubber material is silicone, and preferably is FDA food-grade silicone. The elastomeric material comprising the body 102 and the hygienic chewable extension 110 can be the same or can be different, including any combination of the materials referenced above.

In some embodiments, the elastomeric material comprising the hygienic chewable extension 110 creates a hygienic barrier between the outer surface 112 and the inner surface 114. The hygienic barrier prevents germs and other particles from crossing between the cavity 120 and the outer surface 112. For example, the hygienic barrier prevents germs and other particles on the caregivers' finger inserted into the cavity 120 from entering the teething child's mouth, even when the hygienic chewable extension 110 is inserted into the teething child's mouth. The hygienic barrier also prevents saliva, germs, and other particles from crossing between the outer surface 112 and the cavity 120. For example, the hygienic barrier prevents saliva from the teething child from entering the cavity 120.

In some embodiments, a second cavity 140 may be defined between at least a portion of the outer surface 112 and the inner surface 114. The second cavity 140 and/or third cavity 142 may be filled with a liquid or gel. The liquid or gel can act as a coolant to the teething child's gums. The liquid or gel can either act naturally as a coolant, or can be cooled by placing the multi-purpose teething device in the refrigerator or freezer. The liquid or gel acts as a coolant by retaining their cooling properties after removing the device from the refrigerator or freezer. In some embodiments, the liquid or gel can be, for example, water, hydroxypropyl methylcellulose, ammonium nitrate, hydroxyethyl cellulose, silica gel, propylene glycol, or any other food grade, freezable liquid or gel, or a combination thereof. If the liquid or gel is water, the water can be distilled or sterile water. Moreover, the liquid or gel may be any other material that is non-toxic and has favorable cooling properties. In some embodiments, the liquid or gel is sealed within the second cavity 140 and/or the third cavity 142. In other embodiments, the liquid or gel can be removed from the second cavity 140 and/or third cavity 142 and replaced. In some embodiments, the second cavity 140 is fluidly coupled with the third cavity 142, thereby creating one large continuous cavity. In other embodiments, and as shown in FIG. 1, the second cavity 140 is not fluidly coupled with the third cavity 142, thereby creating two distinct cavities.

Different embodiments of the multi-purpose teething device contain different combinations of the second and third cavities. Some embodiments only include the second cavity 140 and not the third cavity 142. Some embodiments only include the third cavity 142 and not the second cavity 140. Some embodiments include neither the second cavity 140 nor the third cavity 142. And some embodiments include both the second cavity 140 and the third cavity 142.

The distance between the outer surface 112 and the inner surface 114 of the hygienic chewable extension 110 defines a thickness that is sufficient to prevent perforation by a teething child's teeth. The thickness varies depending on whether the second cavity 140 is present. In some embodiments without the second cavity 140, the thickness is between 0.5 cm (0.2 in) and 2.5 cm (0.99 in). In some embodiments with the second cavity 140, the thickness is between 0.5 cm (0.2 in) and 3.0 cm (1.18 in).

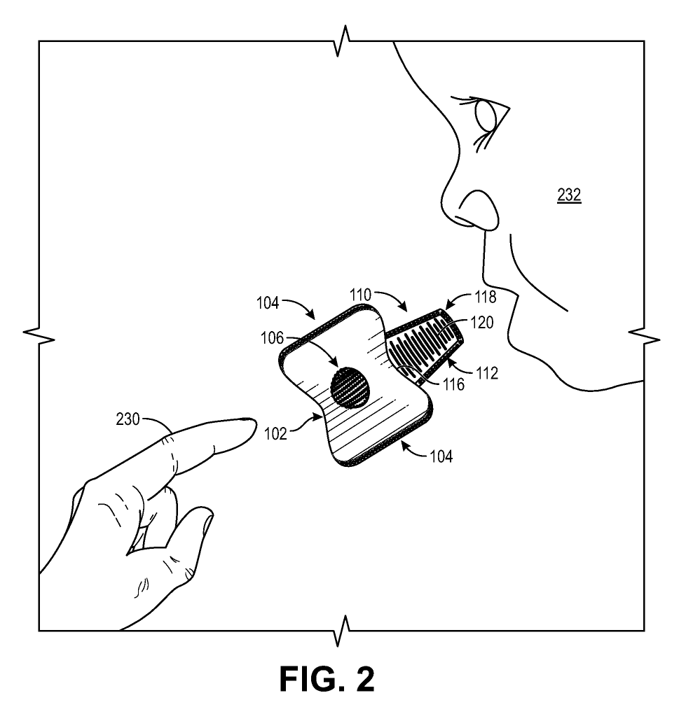

FIG. 2 illustrates a possible use of one embodiment of the multi-purpose teething device. The caregiver may insert their finger 230 into the cavity 120. The caregiver can then insert the hygienic chewable extension 110 into the teething child's mouth and massage, apply pressure, or allow the teething child to bite down and chew on the hygienic chewable extension 110.

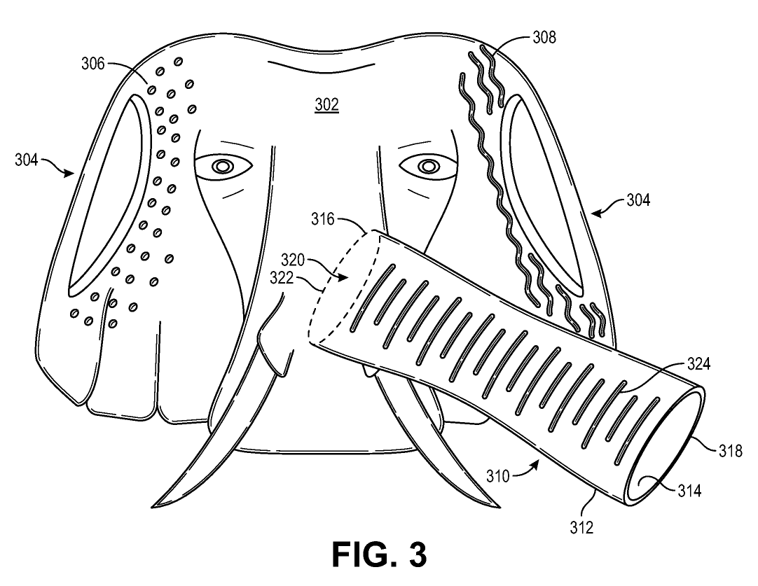

FIG. 3 illustrates another possible embodiment of the multi-purpose teething device. As shown in FIG. 3, a hygienic chewable extension 310 extends outward from a body 302. The body 302 comprises two chewable protrusions 304. The body further includes textured surface 306 and textured surface 308. Textured surface 306 and 308 can be the same or can be different, and can comprise any combination or pattern of offset raised and/or dimpled surfaces capable of providing the teething child with a different sensation.

The hygienic chewable extension includes an end 316 connected to the body 302 and an end 318 distal to the body 302. The distance between the end 316 and the end 318 can be between 1.27 cm (0.5 in) and 10.16 cm (4 in). In one embodiment, the distance is about 5 cm (1.97 in). In some embodiments, the end 318 is closed. This provides a seal at the distal end of the hygienic chewable extension 310, preventing germs or other particles from crossing from a cavity 320 within the hygienic chewable extension to an outer surface 312 of the hygienic chewable extension.

As previously mentioned, the hygienic chewable extension 310 further includes the outer surface 312 and an inner surface 314. The outer surface 312 of the hygienic chewable extension 310 can include a texture 324. The texture 324 can cover a portion of or all of the hygienic chewable extension 310, and can comprise any combination or pattern of offset raised and/or dimpled surfaces capable of providing the teething child with a different sensation. The inner surface 314 defines a cavity 320 within the hygienic chewable extension 310. The hygienic chewable extension 310 includes an opening 322 to the cavity 320.

The cavity 320 is adapted to receive at least a portion of a human finger through the opening 322. The opening 322 can be roughly circular, ovular, rectangular, triangular, or any other shape capable of providing an adult finger access to the cavity 320. The opening 322 comprises a width sufficient to allow an adult caregiver to insert their finger through the opening 322 and into the cavity 320. In some embodiments, this width is between 1 cm (0.39 in) and 4.06 cm (1.60 in).

In some embodiments, the opening 322 is at the end 316 connected to the body 302. In other embodiments, the opening 322 is located between the two ends of the hygienic chewable extension 310, allowing a caregiver to bend their finger to insert it into the cavity 320. In yet other embodiments, the opening 322 is located anywhere along the hygienic chewable extension 310 that provides a means for a caregiver to insert a finger into the cavity 320. In yet another embodiment, the opening 322 is located on the body of the device so that a caregiver's finger is inserted through the body 302 and into the hygienic chewable extension 310.

The cavity 320 can extend within the hygienic chewable extension 310 along a substantial length of the hygienic chewable extension 310. For example, the cavity 320 can extend at least half the distance between the two ends of the hygienic chewable extension 310. In some embodiments, the cavity 322 can extend at least three-quarters of the distance between the two ends of the hygienic chewable extension 310. In some embodiments, the cavity can extend substantially all the way between the two ends of the hygienic chewable extension 310, thereby allowing a human finger to extend within the substantially entire length of the hygienic chewable extension. Moreover, the cavity 320 defined by the inner surface 314 has a width between 1 cm (0.39 in) and 4.06 cm (1.60 in). In some embodiments, the cavity 320 has a substantially constant width along its length. In other embodiments, the cavity 320 may be tapered so that the width of the cavity 320 narrows or widens along the length of the cavity 320.

Accordingly, the cavity 320 can be any shape capable of receiving a human finger. For example, in some embodiments, the cavity 320 is substantially cylindrical. In other embodiments, the cavity 320 may be a prism, such as a triangular prism, a rectangular prism, a pentagonal prism, or any other polyhedral prism. In yet other embodiments, the cavity 320 may not be a perfect prism, but instead take a pyramidal or other distorted prism shape, so long as a human finger may be inserted along a majority of the length of the cavity 320.

In some embodiments, the outer surface 312 of the hygienic chewable extension 310 may match the shape of the cavity 320. For example, the cavity 320 may be substantially cylindrical, and the outer surface 312 of the hygienic chewable extension 310 may be substantially cylindrical. In other embodiments, the outer surface 312 of the hygienic chewable extension 310 does not match the shape of the cavity 320. For example, the cavity 320 may be substantially cylindrical, while the outer surface 312 of the hygienic chewable extension 310 is a rectangular prism.

Further, as shown in FIG. 3, the multi-purpose teething device can form a shape. The shape can substantially mimic the shape of an animal, plant, or other object that may be pleasing to a teething child. For example, in FIG. 3, the body 302 and the hygienic chewable extension 310 form the shape of an elephant face, ears, and trunk. Examples of other potential shapes the multi-purpose teething device could take include a bird, a cactus, or an airplane. Any shape capable of having a body with an extension are potential shapes of the multi-purpose teething device.

The various embodiments described above can be combined to provide further embodiments. “About” when used with a measurement refers to a manufacturing tolerance known to one skilled in the art. For example, “about” can be +/−1%, 5% or any other acceptable manufacturing tolerance. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A multi-purpose teething device usable by caregivers and teething children, comprising:
a body that comprises one or more chewable protrusions made of an elastomeric material, wherein at least a portion of the one or more chewable protrusions comprises a textured surface; and
a hygienic chewable extension made of an elastomeric material, the hygienic chewable extension extending outward from the body, and comprising an outer surface, an inner surface, and an opening, wherein the inner surface defines a cavity, and wherein the cavity is adapted to receive at least a portion of a human finger through the opening.

2. The multi-purpose teething device usable by caregivers and teething children of claim 1, wherein the body and hygienic chewable extension to form a shape, and the shape substantially mimics the shape of an elephant face, ears, and trunk.

3. The multi-purpose teething device usable by caregivers and teething children of claim 1, wherein the hygienic chewable extension has two ends, wherein one of the two ends connects to the body and the other one of the two ends is free.

4. The multi-purpose teething device usable by caregivers and teething children of claim 3 wherein the distance between the two ends is between 1.27 cm and 10.16 cm in length.

5. The multi-purpose teething device usable by caregivers and teething children of claim 1, wherein the cavity defined by the inner surface comprises a width between 1 cm and 4.06 cm.

6. The multi-purpose teething device usable by caregivers and teething children of claim 5, wherein the width of the cavity defined by the inner surface remains substantially constant along the length of the hygienic chewable extension.

7. The multi-purpose teething device usable by caregivers and teething children of claim 1, wherein the cavity is substantially cylindrical or prism shaped.

8. The multi-purpose teething device usable by caregivers and teething children of claim 1, wherein the hygienic chewable extension is substantially cylindrical or prism shaped.

9. The multi-purpose teething device usable by caregivers and teething children of claim 1, wherein the opening comprises a width between 1 cm and 4.06 cm.

10. The multi-purpose teething device usable by caregivers and teething children of claim 3, wherein the opening to the cavity is at the end of the hygienic chewable extension that connects to the body.

11. The multi-purpose teething device usable by caregivers and teething children of claim 3, wherein the opening to the cavity, wherein the opening to the cavity is between the two ends of the hygienic chewable extension.

12. The multi-purpose teething device usable by caregivers and teething children of claim 3, wherein the opening to the cavity is on the body.

13. The multi-purpose teething device usable by caregivers and teething children of claim 1, further comprising a second cavity between at least a portion of the outer surface and at least a portion of the inner surface of the hygienic chewable extension.

14. The multi-purpose teething device usable by caregivers and teething children of claim 13, wherein the second cavity between at a least a portion of the outer surface and at least a portion of the inner surface of the hygienic chewable extension comprises a liquid or gel.

15. The multi-purpose teething device usable by caregivers and teething children of claim 14, wherein the liquid or gel is water.

16. The multi-purpose teething device usable by caregivers and teething children of claim 13, further comprising a third cavity in at least a portion of the body, wherein the second cavity between at least a portion of the outer surface and at least a portion of the inner surface of the hygienic chewable extension is continuous with the third cavity in at least a portion of the body.

17. The multi-purpose teething device usable by caregivers and teething children of claim 16, wherein the second cavity and the third cavity comprise a liquid or gel.

18. The multi-purpose teething device usable by caregivers and teething children of claim 13, further comprising a third cavity in at least a portion of the body, wherein the second cavity between at least a portion of the outer surface and at least a portion of the inner surface of the hygienic chewable extension is not continuous with the third cavity in at least a portion of the body.

19. The multi-purpose teething device usable by caregivers and teething children of claim 18, wherein both the second cavity between at a least a portion of the outer surface and at least a portion of the inner surface of the hygienic chewable extension and the third cavity in at least a portion of the body comprises a liquid or gel.

20. The multi-purpose teething device usable by caregivers and teething children of claim 1, further comprising a second cavity in at least a portion of the body.

21. The multi-purpose teething device usable by caregivers and teething children of claim 20, wherein the second cavity in at least a portion of the body comprises a liquid or gel.

22. The multi-purpose teething device usable by caregivers and teething children of claim 1, wherein the body comprises two chewable protrusions.

23. The multi-purpose teething device usable by caregivers and teething children of claim 22, wherein each of the two chewable protrusions comprise a texture, and wherein the textures of the two chewable protrusions are different.

24. The multi-purpose teething device usable by caregivers and teething children of claim 1, wherein the outer surface of the hygienic chewable extension comprises a portion that is textured.

25. The multi-purpose teething device usable by caregivers and teething children of claim 1, wherein the outer surface of the hygienic chewable extension comprises two portions that are textured, and wherein textures of the two portions are different.

26. The multi-purpose teething device usable by caregivers and teething children of claim 1, wherein the elastomeric material is silicone.
